(19) United States
(12) Patent Application Publication
(10) Pub. No.: US 2004/0196399 A1
(43) Pub. Date: Oct. 7, 2004

(54) Device incorporating retina tracking

(76) Inventor: Donald J. Stavely, Windsor, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/405,650

(22) Filed: Apr. 1, 2003

(51) Int. Cl. H04N 5/222

(52) U.S. Cl. 348/333.01

(57) ABSTRACT

Disclosed is an electrical device that incorporates retina tracking. In one embodiment, the device includes a viewfinder that houses a microdisplay, and a retina tracking system that is configured to determine the direction of a user's gaze upon the microdisplay.

### BACKGROUND

Several electronic devices now include microdisplay viewfinders that convey information to the user and, occasionally, which can be used to interface with the device. For example, digital cameras are now available that have viewfinders that contain a microdisplay with which images as well as various selectable features can be presented to the user. In the case of digital cameras, provision of a microdisplay viewfinder avoids problems commonly associated with back panel displays (e.g., liquid crystal displays (LCDs)) such as washout from the sun, display smudging and/or scratching, etc.

Although microdisplay viewfinders are useful in many applications, known microdisplay viewfinders can be unattractive from a user interface perspective. Specifically, when the microdisplay of a viewfinder is used as a graphical user interface (GUI) to present selectable features to the user, it can be difficult for the user to register his or her desired selections. The reason for this is that the tools used to make these selections are separate from the microdisplay. For example, features presented in a display are now typically selected by manipulating an on-screen cursor using “arrow” buttons. Although selecting on-screen features with such buttons is straightforward when interfacing with a back panel display, these buttons are awkward to operate while looking into a viewfinder of a device, particularly where the buttons are located proximate to the viewfinder. Even when such buttons may be manipulated without difficulty, for instance where they are located on a separate component (e.g., separate input device such as a keypad), making selections with such buttons is normally time-consuming. For instance, if an on-screen cursor is used to identify a button to be selected, alignment of the cursor with the button using an arrow button is a slow process. Other known devices typically used to select features presented in a GUI, such as a mouse, trackball, or stylus, are simply impractical for most portable devices, especially for those that include a microdisplay viewfinder.

### SUMMARY

Disclosed is an electrical device that incorporates retina tracking. In one embodiment, the device comprises a viewfinder that houses a microdisplay, and a retina tracking system that is configured to determine the direction of a user's gaze upon the microdisplay.

### BRIEF DESCRIPTION OF THE DRAWINGS

FIG. 1 is a front perspective view of an embodiment of an example device that incorporates retina tracking.

FIG. 2 is a rear view of the device of FIG. 1.

FIG. 3 is an embodiment of an architecture of the device shown in FIGS. 1 and 2.

FIG. 4 is a schematic view of a user's eye interacting with a first embodiment of a viewfinder shown in FIGS. 1 and 2.

FIG. 5 is a flow diagram of an embodiment of operation of a retina tracking system shown in FIG. 4.

FIG. 6 is a blood vessel line drawing, generated by a processor shown in FIG. 3.

FIG. 7 is a schematic representation of a graphical user interface shown in a microdisplay of the device of FIGS. 1-3, illustrating manipulation of an on-screen cursor via retina tracking.

FIG. 8 is a schematic representation of a graphical user interface shown in a microdisplay of the device of FIGS. 1-3, illustrating highlighting of an on-screen feature via retina tracking.

FIG. 9 is a schematic view of a user's eye interacting with a second embodiment of a viewfinder shown in FIGS. 1 and 2.

### DETAILED DESCRIPTION

As identified in the foregoing, selecting and/or controlling features presented in device microdisplays can be difficult using separate controls provided on the device. Specifically, it is awkward to manipulate such controls, such as buttons, while simultaneously looking through the device viewfinder to see the microdisplay. Furthermore, the responsiveness of such separate controls is poor. As is disclosed in the following, user selection and control of displayed features is greatly improved when the user can simply select or move features by changing the direction of the user's gaze. For example, an on-screen cursor can be moved across the microdisplay in response to what area of the microdisplay the user is viewing. Similarly, menu items can be highlighted and/or selected by the user by simply looking at the item that the user wishes to select.

As described below, the direction of the user's gaze can be determined by tracking the user's retina as the user scans the microdisplay. In particular, the device can detect the pattern of the user's retinal blood vessels and correlate their orientation to that of a retinal map stored in device memory. With such operation, on-screen items can be rapidly selected and/or controlled with a high degree of precision.

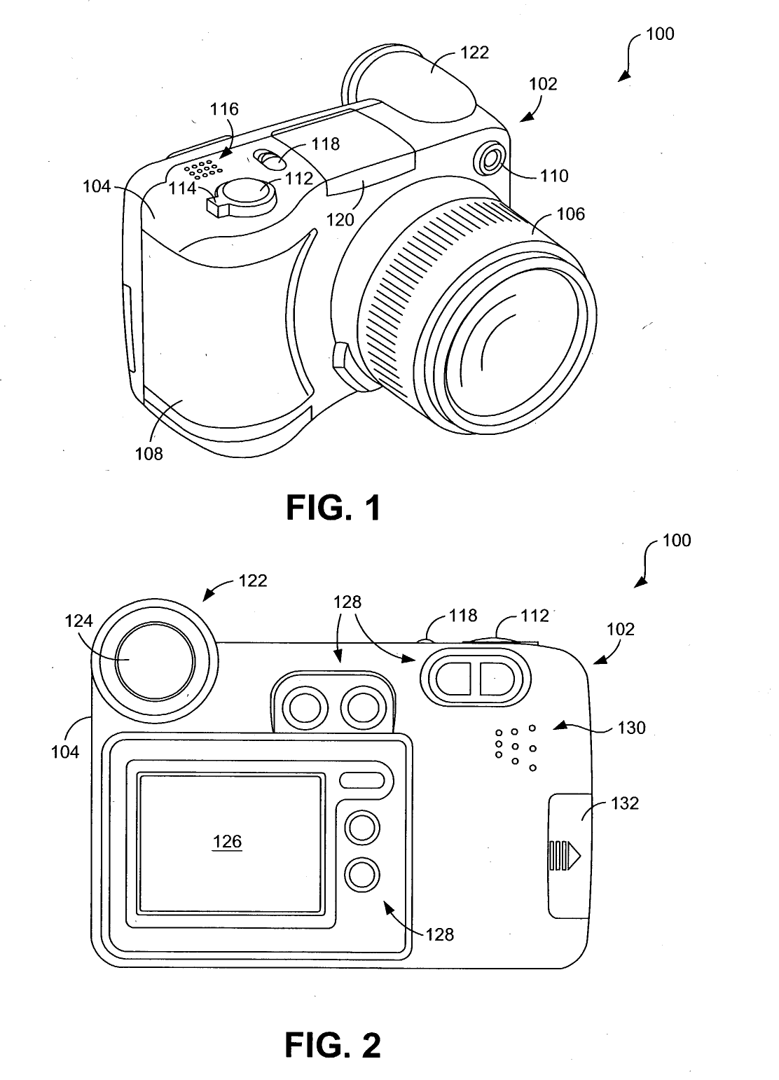

Referring now to the drawings, in which like numerals indicate corresponding parts throughout the several views, FIG. 1 illustrates an embodiment of a device 100 that incorporates retina tracking, which can be used to infer user selection and/or control of features presented in a microdisplay of the device. As indicated in FIG. 1, the device 100 can comprise a camera and, more particularly, a digital still camera. Although a camera implementation is shown in the figures and described herein, it is to be understood that a camera is merely representative of one of many different devices that can incorporate retina tracking. Therefore, the retina tracking system described in the following can, alternatively, be used in other devices such as video cameras, virtual reality glasses, portable computing devices, and the like. Indeed, the retina tracking system can be used with substantially any device that includes a microdisplay that is used to present a graphical user interface (GUI).

As indicated in FIG. 1, the device 100, which from this point forward will be referred to as “camera 100,” includes a body 102 that is encapsulated by an outer housing 104. The camera 100 further includes a lens barrel 106 that, by way of example, houses a zoom lens system. Incorporated into the front portion of the camera body 102 is a grip 108 that is used to grasp the camera and a window 110 that, for example, can be used to collect visual information used to automatically set the camera focus, exposure, and white balance.

The top portion of the camera 100 is provided with a shutter-release button 112 that is used to open the camera shutter (not visible in FIG. 1). Surrounding the shutter-release button 112 is a ring control 114 that is used to zoom the lens system in and out depending upon the direction in which the control is urged. Adjacent the shutter-release button 112 is a microphone 116 that may be used to capture audio when the camera 100 is used in a “movie mode.” Next to the microphone 116 is a switch 118 that is used to control operation of a pop-up flash 120 (shown in the retracted position) that can be used to illuminate objects in low light conditions.

Referring now to FIG. 2, which shows the rear of the camera 100, further provided on the camera body 102 is an electronic viewfinder (EVF) 122 that incorporates a microdisplay (not visible in FIG. 2) upon which captured images and GUIs are presented to the user. The microdisplay may be viewed by looking through a view window 124 of the viewfinder 122 that, as is described below in greater detail, may comprise a magnifying lens or lens system. Optionally, the back panel of the camera 100 may also include a flat panel display 126 that may be used to compose shots and review captured images. When provided, the display 126 can comprise a liquid crystal display (LCD). Various control buttons 128 are also provided on the back panel of the camera body 102. These buttons 128 can be used, for instance, to scroll through captured images shown in the display 126. The back panel of the camera body 102 further includes a speaker 130 that is used to present audible information to the user (e.g., beeps and recorded sound) and a compartment 132 that is used to house a battery and/or a memory card.

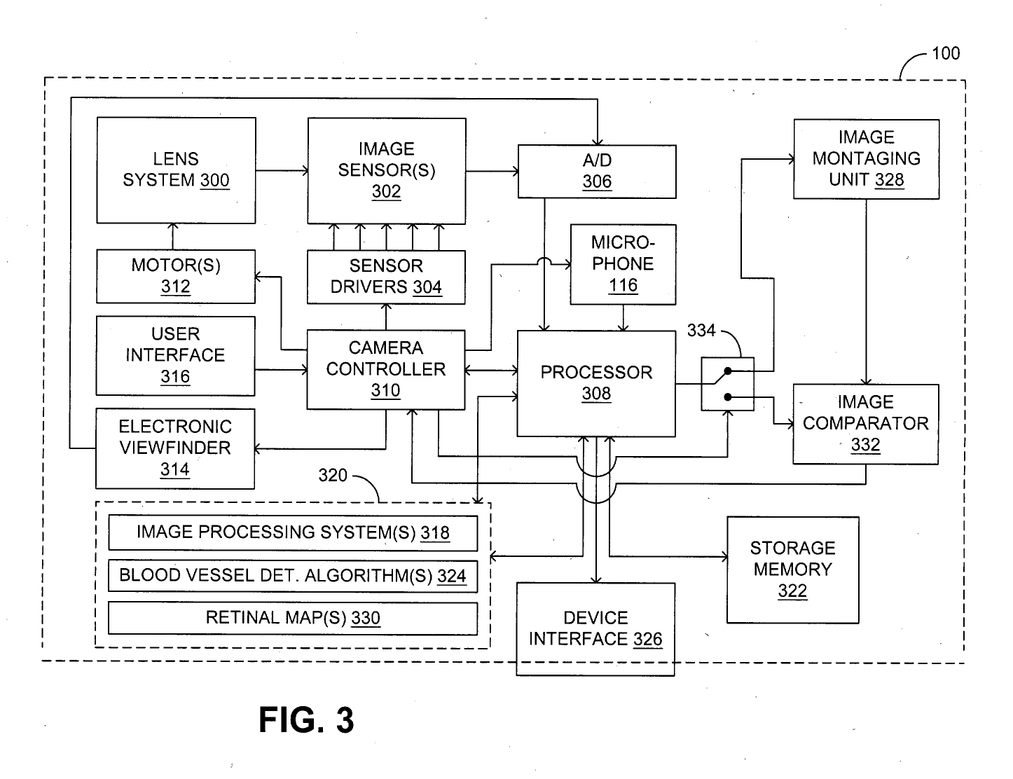

FIG. 3 depicts an example architecture for the camera 100. As indicated in this figure, the camera 100 includes a lens system 300 that conveys images of viewed scenes to one or more image sensors 302. By way of example, the image sensors 302 comprise charge-coupled devices (CCDs) that are driven by one or more sensor drivers 304. The analog image signals captured by the sensors 302 are then provided to an analog-to-digital (A/D) converter 306 for conversion into binary code that can be processed by a processor 308.

Operation of the sensor drivers 304 is controlled through a camera controller 310 that is in bi-directional communication with the processor 308. Also controlled through the controller 310 are one or more motors 312 that are used to drive the lens system 300 (e.g., to adjust focus and zoom), the microphone 116 identified in FIG. 1, and an electronic viewfinder 314, various embodiments of which are described in later figures. Output from the electronic viewfinder 314, like the image sensors 302, is provided to the A/D converter 306 for conversion into digital form prior to processing. Operation of the camera controller 310 may be adjusted through manipulation of the user interface 316. The user interface 316 comprises the various components used to enter selections and commands into the camera 100 and therefore at least includes the shutter-release button 112, the ring control 114, and the control buttons 128 identified in FIG. 2.

The digital image signals are processed in accordance with instructions from the camera controller 310 and the image processing system(s) 318 stored in permanent (non-volatile) device memory 320. Processed images may then be stored in storage memory 322, such as that contained within a removable solid-state memory card (e.g., Flash memory card). In addition to the image processing system(s) 318, the device memory 320 further comprises one or more blood vessel detection algorithms 324 (software or firmware) that is/are used in conjunction with the electronic viewfinder 314 to identify the user's retinal blood vessel and track their movement to determine the direction of the user's gaze.

The camera 100 further comprises a device interface 326, such as a universal serial bus (USB) connector, that is used to download images from the camera to another device such as a personal computer (PC) or a printer, and which can be likewise used to upload images or other information.

In addition to the above-described components, the camera 100 further includes an image montaging unit 328, one or more retinal maps 330, an image comparator 332, and a switch 334. These components, as well as the blood vessel detection algorithms 324 form part of a retina tracking system that is used to infer user selection and/or control of on-screen GUI features. Operation of these components is described in detail below.

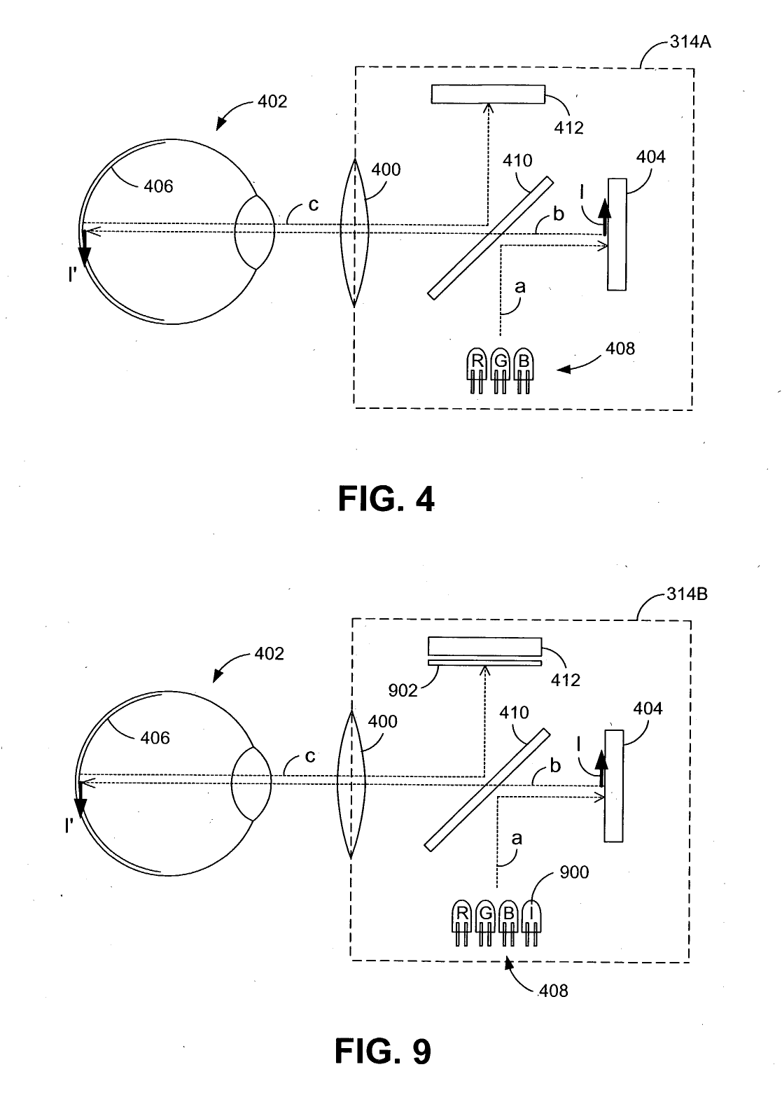

FIG. 4 illustrates a first embodiment of an electronic viewfinder 314A that can be incorporated into the camera 100. As indicated in FIG. 4, the electronic viewfinder 314A includes a magnifying lens 400, which the user places close to his or her eye 402. The magnifying lens 400 is used to magnify and focus images generated with a microdisplay 404 contained within the viewfinder housing. Although element 400 is identified as a single lens in FIG. 4, a suitable system of lenses could be used, if desired. Through the provision of the magnifying lens 400, an image I generated by the microdisplay 404 is transmitted to the user's eye 402 so that a corresponding image I′ is focused on the retina 406 of the eye.

The microdisplay 404 can comprise a transmissive, reflective, or emissive display. For purposes of the present disclosure, the term “microdisplay” refers to any flat panel display having a diagonal dimension of one inch or less. Although relatively small in size, when viewed through magnifying or projection optics, microdisplays provide large, high-resolution virtual images. For instance, a microdisplay having a diagonal dimension of approximately 0.19 inches and having a resolution of 320×240 pixels can produce a virtual image size of approximately 22.4 inches (in the diagonal direction) as viewed from 2 meters.

By way of example, the microdisplay 404 comprises a reflective ferroelectric liquid crystal (FLC) microdisplay formed on a silicon die. One such microdisplay is currently available from Displaytech, Inc. of Longmont, Colo. In that such microdisplays reflect instead of emit light, a separate light source is required to generate images with a reflective microdisplay. Therefore, the electronic viewfinder 314A comprises red, green, and blue light sources in the form of light emitting diodes (LEDs) 408. These LEDs 408 are sequentially pulsed at a high frequency (e.g., 90-180 Hz) in a field sequential scheme so that light travels along path “a,” reflects off of a beam splitter 410 (e.g., a glass pane or a prism), and impinges upon the microdisplay 404. The various pixels of the microdisplay 404 are manipulated to reflect the light emitted from the LEDs 408 toward the user's eye 402. This manipulation of pixels is synchronized with the pulsing of the LEDs so that the red portions of the image are reflected, followed by the green portions, and so forth in rapid succession. Although a reflective microdisplay is shown in the figure and described herein, the microdisplay could, alternatively, comprise a transmissive or emissive display, such as a small LCD or an organic light emitting diode (OLED), if desired. In such a case, the various LEDs would unnecessary.

The light reflected (or transmitted or emitted as the case may be) from the microdisplay 404 travels along path “b” toward the user's eye 402. In that the various color signals are transmitted at high frequency, the eye 402 interprets and combines the signals so that they appear to form the colors and shapes that comprise the viewed scene. Due to the characteristics of the eye 402, a portion of this light is reflected back into the viewfinder 314A along the path “c.” A portion of this light is then reflected off of the user's retina 406, which retroreflects light. This light signal bears an image of the user's retina and, therefore, the user's retinal blood vessel pattern. In that such patterns are unique to each individual, the reflected pattern may be considered a blood vessel “signature.”

The light reflected by the user's eye 402 enters the electronic viewfinder 314A through the magnifying lens 400 and is then reflected off of the beam splitter 410. This reflected image then arrives at a retina image sensor 412 contained within the electric viewfinder housing. The sensor 412 comprises a solid-state sensor such as a CCD. If the sensor 412 is positioned so as to be spaced the same optical distance from the user's eye 402 as the microdisplay 404, the retina image borne by the light incident upon the sensor is a magnified, focused image in which the blood vessels are readily identifiable. The light signal captured by the sensor 412 is provided, after conversion into a digital signal, to the processor 308 (FIG. 3) and can then be analyzed to determine the direction of the user's gaze.

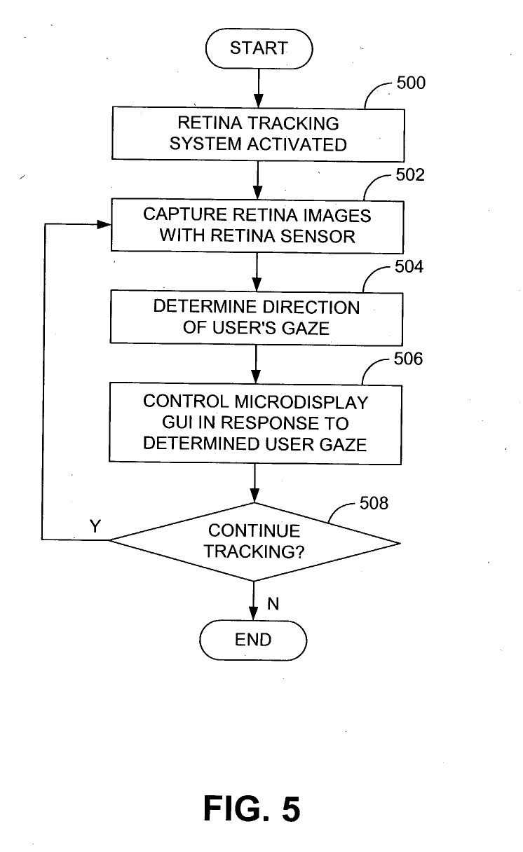

FIG. 5 is a flow chart of an embodiment of retina tracking as used to enable user control of a GUI presented in the microdisplay 404 shown in FIG. 4. Any process steps or blocks described in this flow chart may represent modules, segments, or portions of program code that includes one or more executable instructions for implementing specific logical functions or steps in the process. Although particular example process steps are described, alternative implementations are feasible. Moreover, steps may be executed out of order from that shown or discussed, including substantially concurrently or in reverse order, depending on the functionality involved.

Beginning with block 500 of FIG. 5, the retina tracking system is activated. This activation may occur in response to various different stimuli. For example, in one scenario, activation can occur upon detection of the user looking into the device viewfinder. This condition can be detected, for instance, with an eye-start mechanism known in the prior art. In another scenario, the retina tracking system can be activated when a GUI is first presented using the microdisplay. In a further scenario, the retina tracking system is activated on command by the user (e.g., by depressing an appropriate button 128, FIG. 2).

Irrespective of the manner in which the retina tracking system is activated, the system then captures retina images with the retina image sensor 412, as indicated in block 502. As described above, light reflected off of the retina 406 bears an image of the user's blood vessel signature. This light signal, after conversion into digital form, is provided to the processor 308 (FIG. 3) for processing. In particular, as indicated in block 504, the direction of the user's gaze is determined by analyzing the light signal.

The direction of the user's gaze can be determined using a variety of methods. In one preferred method, the captured retina image is used to determine the area of the microdisplay 404 at which the user is looking. One suitable method for determining the direction of the user's gaze from captured retina images is described in U.S. Pat. No. 6,394,602, which is hereby incorporated by reference into the present disclosure in its entirety. As described in U.S. Pat. No. 6,394,602, the device processor 308 processes retina images captured by the sensor 412 to highlight characteristic features in the retina image. Specifically highlighted are the blood vessels of the retina since these blood vessels are quite prominent and therefore relatively easy to identify and highlight using standard image processing edge detection techniques. These blood vessels may be detected using the blood vessel detection algorithms 324 (FIG. 3). Details of appropriate detection algorithms can be found in the paper entitled “Image Processing for Improved Eye Tracking Accuracy” by Mulligen and published in 1997 in Behaviour Research Methods, Instrumentation and Computers, which is also hereby incorporated by reference into the present disclosure in its entirety. The identified blood vessel pattern is then processed by the processor 308 to generate a corresponding blood vessel line drawing, such as line drawing 600 illustrated in FIG. 6. As shown in that figure, only the details of the blood vessels 602 are evident after image processing.

As the user's gaze moves over the image shown on the microdisplay 404, the retina images captured by the sensor 412 changes. Therefore, before the retina tracking system can be used to track the user's retina, the system must be calibrated to recognize the particular user's blood vessel signature. Calibration can be achieved by requiring the user to independently gaze at a plurality of points scattered over the field of view or a single point moving within the filed of view and capturing sensor images of the retina. When this procedure is used, a “map” of the user's retina 406 can be obtained. Once the calibration is performed, the user's direction of gaze can be determined by comparing current retina images captured by the sensor 412 with the retinal map generated during the calibration stage.

The controller 310 identified in FIG. 3 controls the above-described modes of operation of the retina tracking system. In response to a calibration request input by a new user via the user interface 316, the controller 310 controls the position of the switch 334 so that the processor 308 is connected to the image montaging unit 328. During the calibration stage, a test card (not shown) may be provided as the object to be viewed on the microdisplay 404. When such a card is used, it has a number of visible dots arrayed over the field of view. The new user is then directed to look at each of the dots in a given sequence. As the user does so, the montaging unit 328 receives retina images captured by the sensor 412 and “joins” them together to form a retinal map 330 of the new user's retina 406. This retinal map 406 is then stored in memory 320 for use when the camera is in its normal mode of operation.

During use of the camera 100, the controller 310 connects the processor 308 to the image comparator 332 via the switch 334. The sensor 412 then captures images of the part of the user's retina 406 that can be “seen” by the sensor. This retina image is then digitally converted by the A/D converter 306 and processed by the processor 308 to generate a line drawing, like line drawing 600 of FIG. 6, of the user's visible blood vessel pattern. This generated line drawing is then provided to the image comparator 332 which compares the line drawing with the retinal map 330 for the current user. This comparison can be accomplished, for example, by performing a two dimensional correlation of the current retinal image and the retinal map 330. The results of this comparison indicate the direction of the user's gaze and are provided to the controller 310.

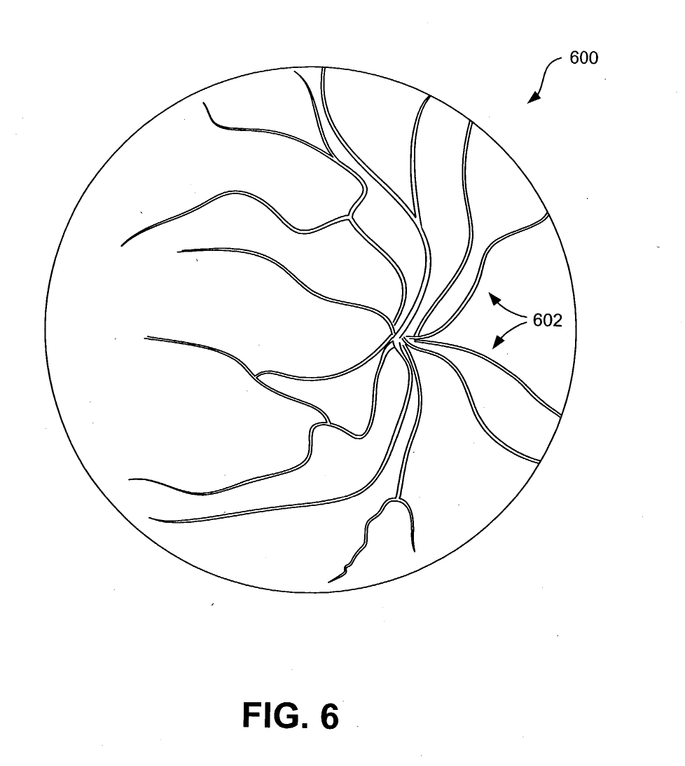

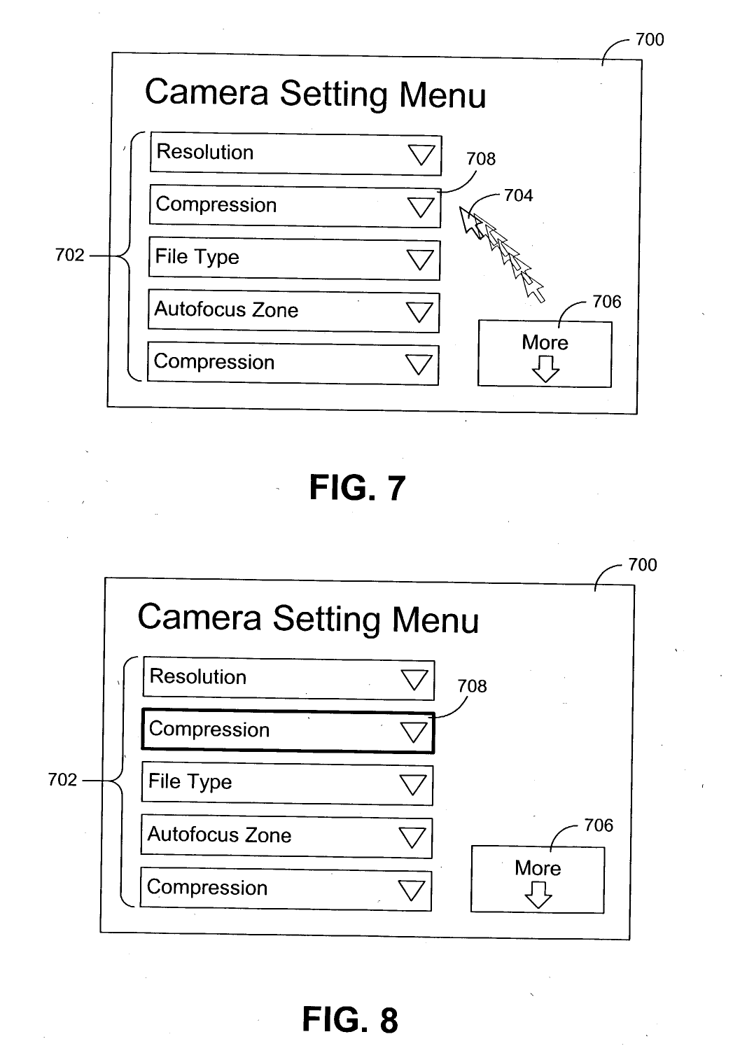

Returning to FIG. 5, once the direction of the user's gaze has been determined, the GUI presented with the microdisplay is controlled in response to the determined gaze direction, as indicated in block 506. The nature of this control depends upon the action that is desired. FIGS. 7 and 8 illustrate two examples. With reference first to FIG. 7, a GUI 700 is shown in which several menu features 702 (buttons in this example) are displayed to the user. These features 702 may be selected by the user by turning his or her gaze toward one of the features so as to move an on-screen cursor 704 in the direction of the user's gaze. This operation is depicted in FIG. 7, in which the cursor 704 is shown moving from an original position adjacent a “More” button 706, toward a “Compression” button 708. Once the cursor 704 is positioned over the desired feature, that feature can be selected through some additional action on the part of the user. For instance, the user can depress the shutter-release button (112, FIG. 1) to a halfway position or speak a “select” command that is detected by the microphone (116, FIG. 1).

With reference to FIG. 8, the GUI 700 shown in FIG. 7 is again depicted. In this example, however, the user's gaze is not used to move a cursor, but instead is used to highlight a feature 702 shown in the GUI. In the example of FIG. 8, the user is gazing upon the “Compression” button 708. Through detection of the direction of the user's gaze, this button 708 is highlighted. Once the desired display feature has been highlighted in this manner, it can be selected through some additional action on the part of the user. Again, this additional action may comprise depressing the shutter-release button (112, FIG. 1) to a halfway position or speaking a “select” command.

With further reference to FIG. 5, the retina tracking system then determines whether to continue tracking the user's retina 406, as indicated in block 508. By way of example, this determination is made with reference to the same stimulus identified with reference to block 500 above. If tracking is to continue, flow returns to block 502 and proceeds in the manner described above. If not, however, flow for the retina tracking session is terminated.

FIG. 9 illustrates a second embodiment of an electronic viewfinder 314B that can be incorporated into the camera 100. The viewfinder 314B is similar in many respects to the viewfinder 314A of FIG. 4. In particular, the viewfinder 314B includes the magnifying lens 400, the microdisplay 404, a group of LEDs 408, a beam splitter 410, and a retina sensor 412. In addition, however, the viewfinder 314B includes an infrared (IR) LED 900 that is used to generate IR wavelength light used to illuminate the user's retina 406, and an IR-pass filter 902 that is used to filter visible light before it reaches the retina sensor 412. With these additional components, the user's retina 406 can be flooded in IR light, and the reflected IR signals can be detected by the sensor 412. Specifically, IR light travels from the IR LED 900 along path “a,” reflects off of the beam splitter 410, reflects off of the microdisplay 404, travels along path “b” through the beam splitter and the magnifying lens 400, reflects off of the user's retina 406, travels along path “c,” reflects off of the beam splitter again, passes through the IR-pass filter 902, and finally is collected by the retina sensor 412.

In this embodiment, the IR LED 900 may be pulsed in the same manner as the other LEDs 408 in the field sequential scheme such that, for instance, one out of four reflections from the microdisplay 404 is an IR reflection. Notably, however, in that the user's eye 402 will not detect the presence of the IR signal, the IR LED 900 need not be pulsed only when the other LEDs are off. In fact, if desired, the IR LED 900 can be illuminated continuously during retina detection. To prolong battery life, however, the IR LED 900 normally is pulsed on and off at a suitable frequency (e.g., 2 Hz). In that IR wavelengths are invisible to the human eye, and therefore do not result in any reduction of pupil size, clear retina images are obtainable when IR light is used as illumination.

The embodiment of FIG. 9 may avoid problems that could occur if the microdisplay 404 relied upon to illuminate the retina to obtain images of the user's blood vessels. In particular, the light provided by the microdisplay 404 may be inadequate when dim images are shown in the microdisplay. Moreover, use of the IR light avoids any complications that may arise in identifying blood vessel patterns reflected by light of the microdisplay 404. Such complications can arise where the viewed image on the microdisplay 404 is highly detailed, thereby increasing the difficulty of filtering out undesired light signals representative of this viewed image which are also borne by the light that reflects off of the user's retina. Because use of the IR light avoids such potential problems, the embodiment of FIG. 9 may, at least in some regards, be considered to be preferred.

While particular embodiments of the invention have been disclosed in detail in the foregoing description and drawings for purposes of example, it will be understood by those skilled in the art that variations and modifications thereof can be made without departing from the scope of the invention as set forth in the following claims.

Various programs (software and/or firmware) have been identified above. These programs can be stored on any computer-readable medium for use by or in connection with any computer-related system or method. In the context of this document, a computer-readable medium is an electronic, magnetic, optical, or other physical device or means that can contain or store programs for use by or in connection with a computer-related system or method. The programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. The term “computer-readable medium” encompasses any means that can store, communicate, propagate, or transport the code for use by or in connection with the instruction execution system, apparatus, or device.

The computer-readable medium can be, for example but not limited to, an electronic, magnetic, optical, electromagnetic, infrared, or semiconductor system, apparatus, device, or propagation medium. More specific examples (a nonexhaustive list) of the computer-readable media include an electrical connection having one or more wires, a portable computer diskette, a random access memory (RAM), a read-only memory (ROM), an erasable programmable read-only memory (EPROM, EEPROM, or Flash memory), an optical fiber, and a portable compact disc read-only memory (CDROM). Note that the computer-readable medium can even be paper or another suitable medium upon which a program is printed, as the program can be electronically captured, via for instance optical scanning of the paper or other medium, then compiled, interpreted or otherwise processed in a suitable manner if necessary, and then stored in a computer memory.

What is claimed is:

1. An electrical device, comprising:
a viewfinder that houses a microdisplay; and
a retina tracking system that is configured to determine the direction of a user's gaze upon the microdisplay.

2. The device of claim 1, wherein the microdisplay is a reflective microdisplay and wherein the device further comprises colored light sources contained within the viewfinder that emit light that is reflected by the microdisplay.

3. The device of claim 1, wherein the retinal tracking system comprises a retina sensor contained within the viewfinder that captures retinal images of the user's eye.

4. The device of claim 3, wherein the retina tracking system further comprises an image montaging unit that receives retina images captured by the retina sensor and joins the images together to form a retinal map of the user's retina.

5. The device of claim 3, wherein the retina tracking system further comprises an image comparator that compares images captured by the retina sensor with a retinal map stored in device memory.

6. The device of claim 3, further comprising an infrared light source contained within the viewfinder that floods the user's eye with infrared light so that reflections of the user's retina can be transmitted to the retina sensor.

7. The device of claim 6, further comprising an infrared-pass filter that is positioned between the user's eye and the retina sensor, the filter being configured to filter out visible light so that it does not reach the retina sensor.

8. The device of claim 1, further comprising a blood vessel detection algorithm stored in memory of the device, the algorithm being configured to identify blood vessels on a surface of the user's retina.

9. A digital camera, comprising:
a lens system;
an image sensor that senses light signals transmitted to it by the lens system;
a processor that processes the light signals;
an electronic viewfinder that houses a microdisplay and a retina sensor, the retina sensor being configured to capture images of a user's retina; and
an image comparator that compares images captured by the retina sensor with a retinal map stored in device memory to determine the direction of the user's gaze relative to the viewfinder microdisplay.

10. The camera of claim 9, wherein the microdisplay is a reflective microdisplay and wherein the viewfinder further houses colored light sources that illuminate the microdisplay.

11. The camera of claim 9, further comprising an infrared light source contained within the viewfinder that illuminates the user's retina with infrared light.

12. The camera of claim 11, further comprising an infrared-pass filter contained within the viewfinder that prevents visible light from reaching the retina sensor.

13. The camera of claim 9, further comprising an image montaging unit that receives retina images captured by the retina sensor and joins the images together to form a retinal map of the user's retina.

14. The camera of claim 9, further comprising a blood vessel detection algorithm stored in camera memory, the algorithm being configured to identify blood vessels on a surface of the user's retina.

15. An electronic viewfinder for use in an electrical device, comprising:
a microdisplay that displays a graphical user interface;
an infrared light source that illuminates a user's retina;
a retina sensor that captures images of the user's retina; and
a retina tracking system that determines the direction of the user's gaze from the captured images to infer a user input relative to the graphical user interface.

16. The viewfinder of claim 15, further comprising an infrared-pass filter that filters visible light before it reaches the retina sensor.

17. A method for controlling a microdisplay, comprising:
illuminating the user's retina with light;
capturing images of the user's retina while the user looks at a device microdisplay;
determining the direction of the user's gaze relative to the microdisplay by analyzing the captured images; and
controlling a feature shown in the microdisplay in response to the determined user gaze.

18. The method of claim 17, wherein illuminating the user's retina comprises illuminating the user's retina with infrared light.

19. The method of claim 17, wherein capturing images comprises capturing images of the user's retina with a retina sensor located within a device viewfinder.

20. The method of claim 17, wherein determining the direction of the user's gaze comprises comparing the captured images with a retinal map stored in device memory.

21. The method of claim 20, further comprising creating the retina map by joining captured images together.

22. The method of claim 17, wherein controlling a feature comprises moving an on-screen cursor in the direction of the user's gaze.

23. The method of claim 17, wherein controlling a feature comprises highlighting an on-screen feature at which the user is looking.

24. A system, comprising:
means for capturing images of a user's retina while the user looks at a device microdisplay;
means for determining the direction of the user's gaze while the user looks at the microdisplay;
means for determining where on the microdisplay the user is looking; and
means for controlling an on-screen feature in relation to where the user is looking.

25. The system of claim 24, wherein the means for determining the direction of the user's gaze comprise a comparator that compares the captured images with a retinal map stored in device memory.
